(19) United States
(12) Patent Application Publication
(10) Pub. No.: US 2023/0219031 A1
(43) Pub. Date: Jul. 13, 2023

(54) PLASMA ASSISTED DIRECT CO2 CAPTURE AND ACTIVATION

(71) Applicant: TECHNISCHE UNIVERSITEIT EINDHOVEN, EINDHOVEN (NL)

(72) Inventors: Fausto Gallucci, Eindhoven (NL); Sirui Li, Eindhoven (NL)

(21) Appl. No.: 18/011,093

(22) PCT Filed: Jul. 2, 2021
(86) PCT No.: PCT/NL2021/050421

§ 371 Date: Dec. 16, 2022

Related U.S. Application Data
(60) Provisional application No. 63/050,671, filed on Jul. 10, 2020.

(51) Int. Cl. B01D 53/02; B01J 20/34; C25B 1/02; C25B 15/08

(52) U.S. Cl. CPC B01D 53/02; B01J 20/3483; C25B 1/02; C25B 15/081; B01D 2257/504; B01D 2259/818; B01D 2259/40098

(57) ABSTRACT

The present invention relates to a process for CO₂ capture and production of CO. The present invention also relates to an apparatus for CO₂ capture and production of CO. An object of the present invention is to provide a sustainable process for the capture CO₂ and convert it into CO. Another object of the present invention is to provide a process for the direct production of valuable chemicals through capture and conversion of CO₂.

The present invention relates to a process for CO₂ capture and production of CO. The present invention also relates to an apparatus for CO₂ capture and production of CO.

### FIELD OF THE INVENTION

The increase of greenhouse gas (GHG) emission has resulted in climate changes worldwide and made a destructive impact on the ecosystems. CO₂ as the primary GHG contributes to approximately 55% of total yearly emission. The atmospheric concentration of CO₂ has been increasing rapidly during the past century and reached a new peak of 408.5 ppm in 2018. To address this issue, various policies and regulations have been made by governments and organizations across the globe to reduce carbon emission. On the other hand, growing attention has been paid to the research and development of innovative technologies for carbon capture and utilization. During the past ten years, the conversion of CO₂ into fuels or value-added chemicals has become a hot topic as it not only respond to the urgent need of climate change but also make use of the waste CO₂ as a carbon source. In addition, it serves as a potential solution for energy storage. By producing chemicals as energy carriers from recycled CO₂ through reactions driven by renewable energy, it is possible to form a closed-loop production process of carbon-neutral fuels. This is in line with the concept of “power to gas” which could play a significant role in the future energy system.

Due to the strong double bond, the CO₂ molecules are very stable and requires a large amount of energy for dissociation. Conventional approaches are often accompanied by high temperature and pressure, resulting in drawbacks such as low energy efficiency, high operation and maintenance cost. This motivates researchers to explore alternative methods such as electrochemical, solar chemical and biochemical conversion.

In recent years, there is a growing interest in CO₂ conversion by plasma, especially non-thermal plasma technology. The energetic electrons in plasma are capable to activate molecules through ionization, excitation and dissociation, making the thermodynamically unfavorable reactions occur at mild condition. Different reactions can be performed by plasma for the conversion of CO₂, for example, splitting, hydrogenation (CO₂+H₂), dry methane reforming (CO₂+CH₄) and artificial photosynthesis (CO₂+H₂O).

For the capture of CO₂, pressure swing adsorption (PSA) and temperature swing adsorption (TSA) are commonly used methods in adsorption technology and the regeneration of sorbent is done through modulation of temperature and pressure.

An object of the present invention is to provide a sustainable process for the capture CO₂ and convert it into CO.

Another object of the present invention is to provide a process for the direct production of valuable chemicals through capture and conversion of CO₂.

### STATEMENTS OF THE INVENTION

The present invention thus relates to a process for CO₂ capture and production of CO, the process comprising:
i) providing a CO₂ containing gas flow;
ii) adsorbing CO₂ from the CO₂ containing gas flow on a sorbent;
iii) applying plasma conditions on the CO₂ adsorbed sorbent to allow for desorption of CO₂ from the CO₂ adsorbed sorbent and conversion to CO;
iv) collecting CO from the gas flow of step iii).

The key of this concept is the one-step desorption and conversion of CO₂ inside the plasma reactor.

In an example the gas flow of step iii) is again subjected to step ii) for adsorbing unreacted CO₂. The temperature of desorption can be tuned between room temperature and 300° C.

In an example air is used in step i) as CO₂ containing gas flow.

In an example steps ii) and iii) are carried out in parallel for continuous capture and conversion of CO₂.

In another example steps ii) and iii) are carried out in series for capture and conversion of CO₂ with recycle of unreacted CO₂.

In an example step iii) is carried out in presence of H₂ for the production of syngas, wherein the ratio between H₂ and CO is preferably in a range from 1:1 to 6:1.

In an example H₂ is produced from electrolysis.

In an example the plasma conditions applied include a frequency of 50 kHz -1 MHz and a discharge power of 10 W-2 kW.

In an example the sorbent is chosen from the group of hydrotalcites, zeolites, activated carbon, solid supported amines, solid supported metal organic frameworks, or any combination thereof.

In an example the shape of the sorbent is chosen from the group of pellets, spheres and 3D printed structures for optimizing the plasma discharge and the adsorption capacity and minimizing the pressure drop.

The present invention also relates to an apparatus for CO₂ capture and production of CO comprising at least two reactors connected in parallel, wherein at least one reactor is configured for adsorbing CO₂ from the CO₂ containing gas flow on a sorbent and at least one reactor is configured for desorption of CO₂ from the CO₂ adsorbed sorbent and conversion to CO, wherein the at least two reactors include means for applying plasma conditions.

The present invention also relates to an apparatus for CO₂ capture and production of CO comprising at least two reactors connected in series, wherein at least one reactor is configured for adsorbing CO₂ from the CO₂ containing gas flow on a sorbent and at least one reactor is configured for desorption of CO₂ from the CO₂ adsorbed sorbent and conversion to CO, wherein the at least two reactors include means for applying plasma conditions.

The present invention also relates to the use of plasma-based CO₂ dissociation for syngas production.

The present invention also relates to the use of syngas produced as discussed above for the production of hydrocarbons.

The present inventors thus developed a non-thermal plasma-based method for CO₂ capture and utilization. Using the combination of solid sorbent and non-thermal plasma, adsorbed CO₂ can be desorbed by plasma and converted into CO in the same step. Two separate processes, CO₂ capture and utilization can be merged into one unit, hence reduce process complexity and save the cost for CO₂ treatment.

The present invention will now be further described with reference to the following non-limiting examples.

It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

### DETAILED DESCRIPTION OF INVENTION

The experimental investigation on plasma induced desorption and splitting of CO₂ will be presented here.

### BRIEF DESCRIPTION OF THE DRAWINGS

FIG. 1 depicts a schematic diagram of the experimental set-up.

FIG. 2 depicts a DBD plasma reactor packed with solid sorbent.

FIG. 3 depicts (a) concentration of CO₂ in the gas outlet of the reactor; (b) differential volumetric flow of CO₂ in outlet gas as a function of time during adsorption tests.

FIG. 4 depicts (a) CO₂ concentration in the gas outlet of the reactor; (b) differential volumetric flow of CO₂ in outlet gas as a function of time during the desorption tests.

FIG. 5 depicts the CO₂ concentration in the case of fresh hydrotalcite sample treat by plasma.

FIG. 6 depicts the CO₂ concentration affected by switching the plasma on and off.

FIG. 7 depicts the concentration of CO during plasma exposure as a function of time.

FIG. 8 depicts the selectivity of CO as a function of time.

FIG. 9 depicts reaction routes of plasma desorption-based CO₂ splitting with hydrotalcite.

FIG. 10 depicts plasma-based CO₂ capture and conversion for “power to gas/liquid” via (A) syngas production; (B) direct production of oxygenates and hydrocarbons.

FIG. 11 depicts energy requirement for plasma process to be integrated with GTCC power plants.

FIG. 12 depicts the periodic operation of reactors in parallel.

FIG. 13 depicts the energy efficiency and the amount of CO produced as a function of operation time for a single reactor.

FIG. 14 depicts the periodic operation of reactors in series.

FIG. 15 depicts the concentration of CO and CO₂ during desorption of a single reactor and operation of two reactors in series.

### EXPERIMENTAL SET-UP

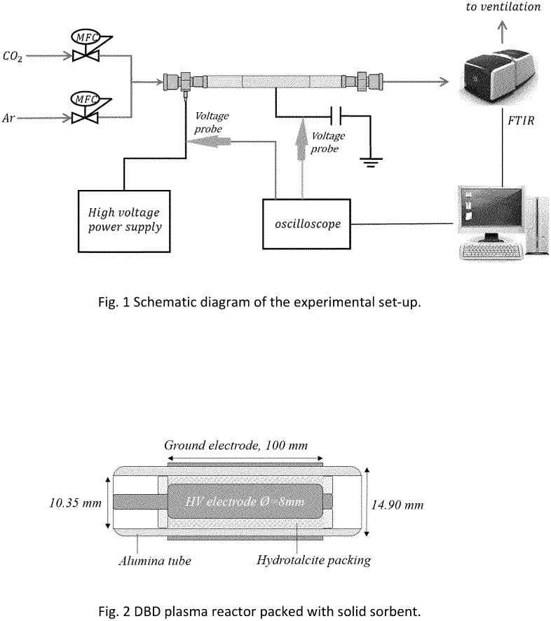

The experimental set-up used in this series of tests is shown in FIG. 1. CO₂ and Ar were fed into the plasma reactor with the flow rate controlled by two separate mass flow controllers (Bronkhorst). An AC high voltage power supply (AFS G15S-150K) was connected to the reactor for the generation of plasma. The voltage across the reactor was measured by using a 1:1000 high voltage probe (Tektronics P6015A), and a 100 nf capacitor was connected between the ground electrode and the grounding point. A 1:10 probe was used to measure the voltage across this capacitor and the waveforms were recorded by a digital oscilloscope (Picoscope 3405D). The discharge power was calculated from the Lissajous figure which was generated from the waveforms of voltage across the reactor and the voltage across the capacitor. The composition of outlet gas from the reactor was analyzed by using a Fourier Transform Infrared Spectroscopy (FTIR) spectrometer (Agilent Technology, Cary 630). The FTIR spectra were recorded through the software Kinetic Pro and the concentration of CO₂, CO was calculated through the software Microlab with pre-calibrated data. The set-up was controlled via a customized Labview interface which was installed on a lab computer.

A coaxial-cylinder DBD plasma reactor was installed in the experimental set-up. As shown in FIG. 2, the reactor wall is made of an alumina tube with an external and internal diameter of 14.90 mm and 10.35 mm correspondingly. A metallic mesh is attached to the outside of this tube, acting as the ground electrode. A stainless-steel rod with a diameter of 8 mm is connected to the power supply and placed inside this tube, acting as the high voltage electrode. The discharge gap is kept as 1.175 mm and the length of the discharge region is 100 mm. 3.60 g commercially available hydrotalcite pellets (PURAL MG 30, Sasol) have been modified into a size range 250-355 mm and packed inside the discharge region. Hydrotalcite is a CO₂ sorbent due to its high thermal stability, fast sorption kinetics and high selectivity towards CO₂. For the comparison study, quartz sand within the same size range was packed into the reactor and tested under the same condition. Characterization study including SEM, BET and XRD was performed with hydrotalcite sample before and after plasma exposure.

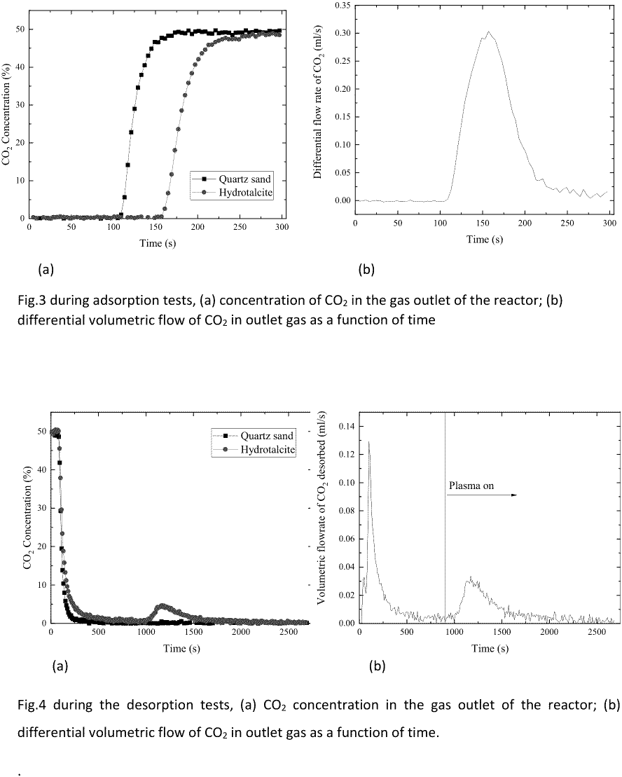

First, the DBD reactor was flushed with Ar flow (40 ml/min). Then the feed gas flow was switched to a gas mixture (50% CO₂ and 50% Ar) with a total flow rate of 40 ml/min to be sent to the reactor packed with the hydrotalcite for the adsorption tests. The same procedure was applied to the reactor packed with quartz sand. The concentration of CO₂ in the gas outlet was monitored during the adsorption tests and results are shown in FIG. 3a. In both cases, CO₂ concentration started from 0 % at the beginning and reached 50% at the end. As the quartz sand does not adsorb CO₂, the change in concentration of CO₂ in the reactor packed with quartz sand was mainly caused by the flow switching. While in the case of hydrotalcite, besides the influence caused by flow switching, CO₂ was adsorbed until the sorbent was saturated, leading to a longer time required to reach 50% concentration. Using the quartz sand case as the control group, the CO₂ adsorption on hydrotalcite can be indicated by the differential flow of CO₂ in outlet gas between the tested two cases and the results are indicated in FIG. 3b. The total amount of CO₂ adsorbed during the tested 5 minutes is 19.72 ml, corresponding to an adsorption capacity of 0.23 mmol/g.

After the adsorption, the desorption tests were performed. The feed gas was switched to 100% Ar with a flow rate of 40 ml/min. After 900 seconds of flushing, plasma was ignited and operated with 7 kV voltage at 50 kHz. The CO₂ concentration in the outlet gas is shown in FIG. 4a. Comparing with the case of quartz sand, there is a slower drop in concentration during the first 900 s. This was caused by CO₂ released from hydrotalcite due to the Ar flushing. After the plasma ignition, the concentration of CO₂ increased and then decreased in the case of hydrotalcite, and this was not observed in the case with quartz sand. The increase in concentration started around 1000 s and reaches to its peak value of 4.64% at 1172 s. Considering the delay in pipeline transportation and measurement time in the experimental system, it can be concluded that the plasma-induced desorption took place very quickly after the plasma ignition.

Using the differential flow rate of CO₂ between two cases, the net desorption of CO₂ can be indicated as shown in FIG. 4b. The first desorption peak was caused by Ar flush while the plasma contributed to the second peak, corresponding to the 15.48 ml and 14.95 ml of CO₂ desorbed. The total amount of CO₂ desorbed (30.43 ml) is larger than the amount measured in adsorption tests. The main reason is that CO₂ was existing in the hydrotalcite sample before the adsorption tests. To quantify this amount, hydrotalcite sample was flushed with 40 ml/min Ar flow and then exposed directly with plasma under the same condition without the adsorption stage. The concentration of CO₂ in the gas outlet is shown in FIG. 5a. Even without the adsorption stage, there was still CO₂ desorbed, and the total amount of CO₂ desorption for 2000 s of plasma exposure is 11.38 ml. It should be noted that besides the CO₂ capture from the air before the adsorption stage, the decarbonisation of hydrotalcite sample could also release CO₂. CO was also detected during the plasma exposure.

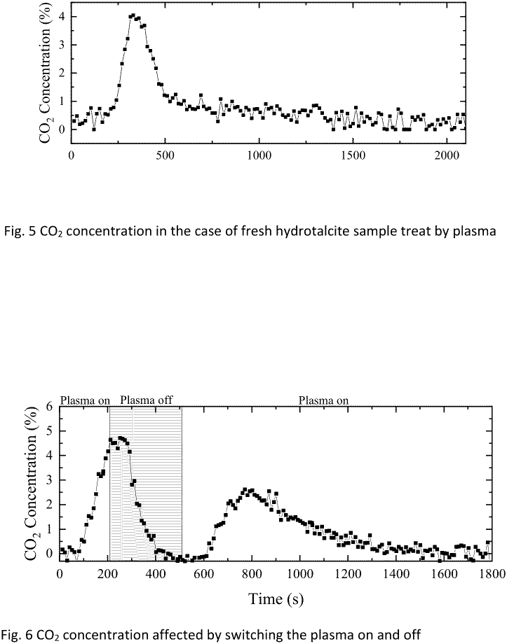

Another test was performed to investigate the time required for desorption induced by plasma. The same amount of hydrotalcite sample was pre-saturated with CO₂ and exposed to plasma under the same condition. During this test, plasma was switched off at 210 s and then switched back on at 510 s, the concentration of CO₂ is shown in FIG. 6. Similar to previous cases, plasma-induced CO₂ desorption was observed during the first period (0-210 s). shortly after switching off the plasma, the concentration decreased to 0% from 270 s to 500 s. from 600 s, the increase of CO₂ concentration was again observed. It needs to be considered that there is a delay of 50-100 s which is caused by gas passing through pipeline and measurement time. This phenomenon indicates that instant “on-off” control of plasma-induced CO₂ desorption can be achieved. Such a feature is difficult to be achieved with the conventional thermal approach. Plasma-induced desorption is more significant and rapid, indicating that the plasma-induced desorption is related to the effect of bombardment by active species such as energetic electrons, ions, radicals and excited molecules. Since those active species are generally short-lived and only can be generated when plasma is on, the switching of plasma is instantly affecting desorption of CO₂ as observed here. However, the contribution from plasma heating cannot be completely ruled out.

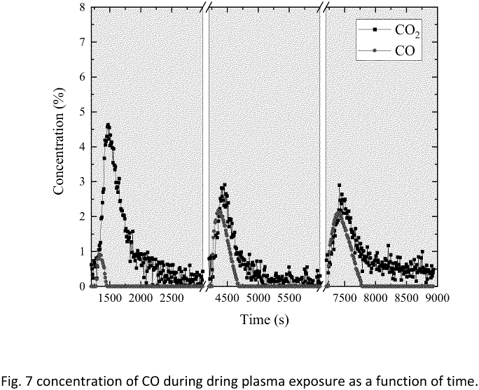

To investigate the CO production during plasma-induced desorption, three consecutive cycles of CO₂ adsorption and desorption were performed with hydrotalcite packed DBD reactor. In each cycle, a gas mixture of 20 ml/min Ar and 20 ml/min CO₂ was used in the adsorption phase for 300 s, then the flow was switched to 40 ml/min Ar for 900 s of flushing, followed by plasma exposure for 1800 s. Quartz sand was also tested under the same condition as the control group. The concentration of CO₂ in the outlet gas was monitored during the entire 3 cycles (as shown in supportive information FIG. S1). Because CO was only produced by plasma exposure, the concentration of CO₂ and CO during this period is shown in FIG. 7.The desorption of CO₂ is more significant in the first cycle than the following two cycles, the maximum concentration of CO₂ detected is 4.64%. In the case of cycle 2 and cycle 3, the maximum concentration did not exceed 2.95%. The total amount of CO₂ desorbed for cycle 2 and cycle 3 is in the range 8.66-12.26 ml, while more than 15 ml of CO₂ is desorbed in cycle 1. An opposite tendency was observed in the case of CO production. It can be seen from FIG. 6 that CO production in cycle 1 is much lower than the other two cycles, the maximum concentration is less than 1% and the total amount produced is 0.69 ml. In cycle 2 and cycle 3, the maximum CO concentration both exceed 2% with the total amount of 4.00 ml and 4.83 ml correspondingly. This difference is attributed to water released from hydrotalcite. The hydrotalcite sample used in this test contains H₂O in its interlayer and H₂O from the air can be adsorbed before the tests, those H₂O was later released during plasma exposure. The relative humidity of the gas flow increased from 17 to 30% during the plasma exposure in the first cycle, while the humidity stays at a level of 15-17% during cycle 2 and 3. The existence of H₂O has a negative effect on CO₂ conversion in the plasma due to the interaction between dissociated products of H₂O and CO₂. For example, OH radical produced from water dissociation quickly recombines with CO to produce CO₂, hence limits the CO₂ conversion. In the present case, H₂O released from the sample during plasma exposure led to less CO₂ converted to CO, hence there is low production of CO but high CO₂ desorption in cycle 1.

It should be also mentioned that the CO₂ was detected until the end of the plasma exposure even the concentration is very below 0.5%. However, CO was only detected at the beginning of plasma exposure. Apart from cycle 1, the average time of CO production for cycle 2 and 3 is in the range between 410 to 530 s. During this period of CO production, the average conversion of CO₂ is 41.14%, and energy efficiency for CO₂ splitting is 0.41%. Comparing to other work with DBD reactor, this conversion is higher but the energy efficiency is very low. The typically reported CO₂ conversion and energy efficiency with DBD reactor are up to 30% and 5-10% respectively. One of the main reasons is because Ar with high concentration was used as the carrier gas. Due to the presence of Ar with high concentration, the energy was mainly used for the ionization and excitation of Ar molecule instead of the activation of CO₂, hence the energy efficiency is low. At the same time, the breakdown voltage is decreased due to the existence of Ar, resulting in higher mean electron energy and electron density, hence the conversion of CO₂ is enhanced.

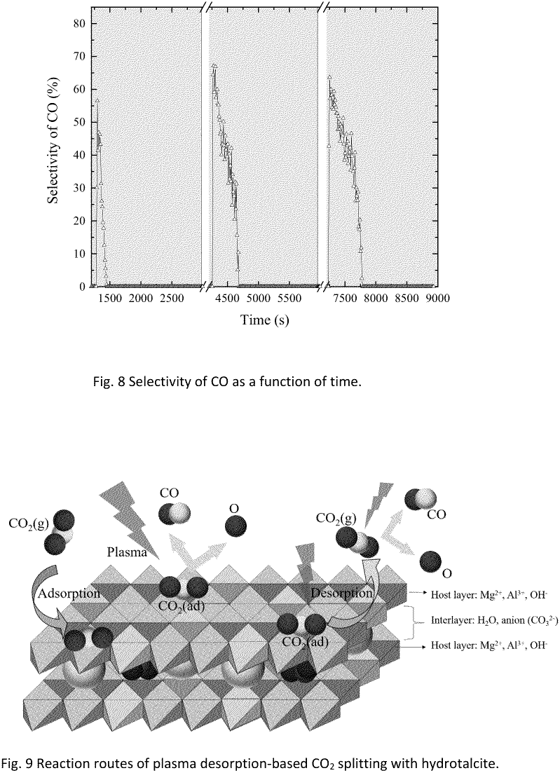

Although CO was the only carbon-containing product from CO₂ splitting, considering the reactant, in this case, is the adsorbed CO₂, both gas-phase CO₂ and CO can be regarded as products during plasma exposure. The selectivity of CO has a transient behavior as shown in FIG. 8. During every three cycles, the highest selectivity was reached at the beginning of plasma exposure, then it decreased to zero with the time. The peak selectivity of CO in cycle 2 and cycle 3 exceed 63%. This indicates that at the beginning, most of the adsorbed CO₂ was converted to CO rather than simply desorbed as gas-phase CO₂. With longer plasma exposure, gas-phase CO₂ became the major product, and later became the only product when there is no CO but still a low concentration of gas-phase CO₂ produced. Such transient behavior is related to the mechanism and rate of CO₂ desorption and splitting. The detailed mechanism of plasma-induced desorption and conversion is not fully understood and a plausible mechanism is shown in FIG. 9. CO₂ was first adsorbed on the hydrotalcite surface during the adsorption stage. When the plasma was generated, energetic electrons, ions as well as excited radicals are produced and bombard the surface of hydrotalcite, causing the adsorbed CO₂ to be desorbed as gas-phase CO₂. At the same time, part of the adsorbed CO₂ could also be directly split and produce gas-phase CO. The CO₂ in the gas phase can be further converted to CO by plasma through electron impact dissociation and ionization. There are also reactions involved that could play an important role, such as CO react with oxygen radical in plasma to produce CO₂, CO₂ dissociation induced by charge transfer between Ar⁺ or Ar₂⁺ and CO₂ molecule. Besides, the release of water from the interlayer hydrotalcite also introduce important reactions such as oxidation of CO by OH radicals.

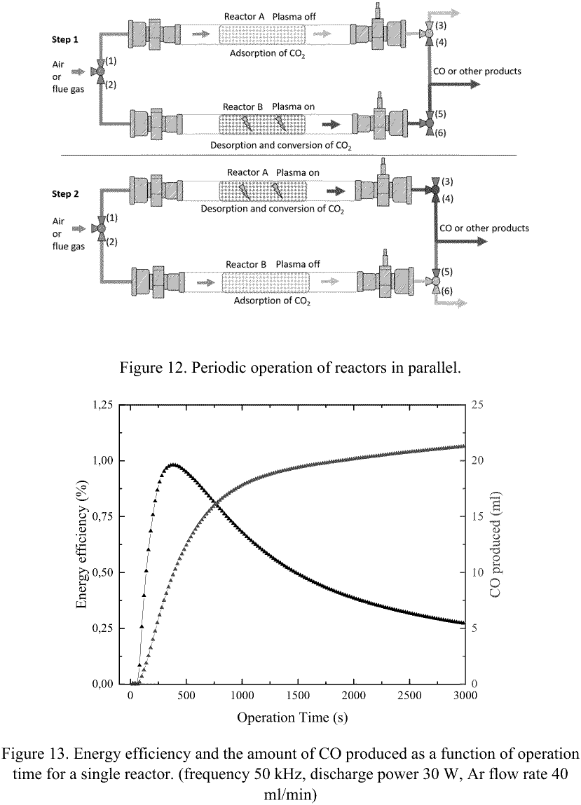

The operation of a plasma reactor for the capture and conversion of CO₂ mainly consists of two stages: 1. Adsorption of CO₂ on the sorbent; 2. Plasma-induced desorption and conversion. After stage 2, the sorbent is regenerated and a new cycle begins with stage 1 again. In this way, it is not possible to continuously capture CO₂ or produce CO with a single reactor. However, this problem can be solved by operating multiple reactors with a designed scheme. An example of such a scheme is shown in FIG. 12. Two reactors (A and B) are connected in parallel. In step 1, valve (1)(3) and (4) are open, air or flue gas flow through reactor A and CO₂ is adsorbed. At the same time, plasma is switched on in reactor B for desorption and conversion. After step 1, valve (1)(3) and (4) are closed while (2)(5)(6) are open. Plasma is switched on in reactor A for the desorption and conversion while gas flow through reactor B for CO₂ adsorption. Two or more reactors can be operated under this scheme cyclically to ensure continuous capture of CO₂ and production of CO.

The key for such operation scheme is to determine proper operation time, especially the time for plasma exposure needs to be considered. It should be noted that the amount of CO produced and the energy efficiency is varying during the desorption stage, an example can be seen in FIG. 13. The energy efficiency increased to 0.98% at the first 400 s then it decreased afterwards and most of the CO was produced in the first 1000 s. Therefore, long time desorption is not necessary for the periodic operation due to the low energy efficiency and low production of CO at a later time. Instead, a proper time for the desorption stage can be selected to optimize the energy efficiency while keeping the amount of CO produced at an acceptable level. For example, if the desorption stops at 1000 s, 17.90 ml CO can be produced with an energy efficiency of 0.68%.

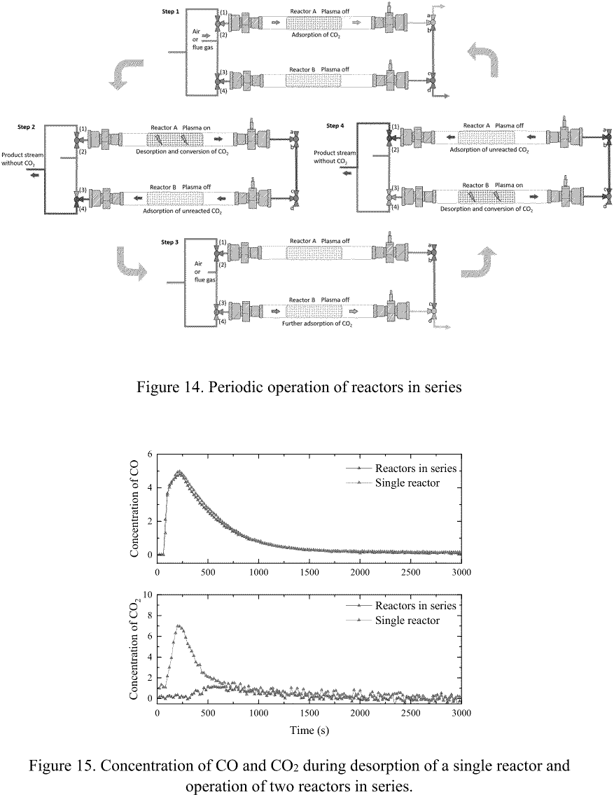

In the case of reactors operate in parallel, each reactor works individually and there is no interaction between reactors. For the production of CO, there is always unconverted CO₂ in the outlet stream and it needs to be separated and recycled. This can be done by another scheme of periodic operation in which reactors are connected in series as shown in FIG. 14. In step 1, air of flue gas flow through reactor A for the adsorption of CO₂. Then plasma is switched on in reactor A to desorb and convert CO₂ from the saturated sorbent. The outlet of gas from reactor A is fed into reactor B and unreacted CO₂ will be adsorbed. In step 3, further adsorption of CO₂ occurs in reactor B till the sorbent is saturated. Finally, in step 4, plasma is switched on in reactor B for desorption and conversion of CO₂ from the sorbent. The outlet gas from reactor B will be fed into reactor A in which the unreacted CO₂ can be adsorbed. After step 4, another cycle starts with step 1 again. In this case, the CO₂ will be “trapped” inside the reactors and CO will be the only product in the outlet stream. The operation scheme is flexible and there are also other possible combinations, for example, step 3 can be replaced by repetition of step 1 and step 2 for saturating the sorbent in reactor B.

The operation of two reactors in series has been tested and the concentration of CO and CO₂ during one desorption step is shown in FIG. 15 and compared with the case of a single reactor. the plasma was sustained at 50 kHz with a discharge power of 30 W. CO₂ concentration in the case of reactors in series was kept below 1% due to the adsorption occurs in the second reactor. The CO concentration is slightly higher in the case of reactors in parallel due to the absence of CO₂ in the outlet stream. despite this insignificant difference, the CO concentration in both cases showed a very similar trend. This indicating the production of CO is not affected by the sorbent in the second reactor. Ideally, a high concentration of CO can be achieved in this way if less or even no carrier gas were used. However, the conversion of CO₂ will also decrease.

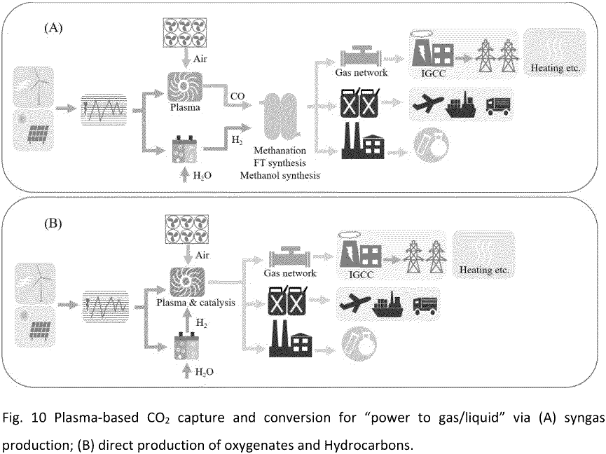

The plasma-based CO₂ capture and conversion described in this invention fit into the concept of “power to gas/liquid” and potential application can be developed for the storage of renewable energy. As shown in FIG. 10A, excessive electricity generated from renewable sources such as wind and solar energy can be used to power the plasma process to capture CO₂ from the air and convert it into CO, along with H₂ produced from electrolysis which is also powered by renewable electricity, syngas can be produced and fed to the later process such as methanation, FT synthesis and methanol synthesis. The end products including CH₄, methanol and other valuable hydrocarbons will be used as fuel, for production of various chemicals, electricity generation or domestic uses such as heating. The plasma process uses only air and renewable electricity as input and it can be operated under a mild condition such as atmospheric pressure and room temperature. This provides an environmental-friendly solution for CO₂ conversion from the point of green chemistry. The captured CO₂ can be directly converted by plasma without requiring separate steps for desorption, compression and transportation, saving energy and reducing the overall process complexity. Due to the rapid switching feature of the plasma process, it is possible to desorb and convert CO₂ with highly dynamic power supply condition, providing the ability to meet the intermittent demand of balancing the dynamic electric power generation from renewable sources.

On the other hand, the syngas production is often been considered as the central element of a “power to gas” system, and the conversion of CO₂/H₂O into syngas is the critical step from both technical and economical point of view. Conventionally, CO₂ is converted to CO through CO-shift process such as reverse water gas shift reaction. Due to the high chemical stability, high activation barrier needs to be overcome for CO₂ conversion and high pressure and temperature conditions are normally applied in the thermal catalytic process. The plasma-based process can directly produce CO from the air without any extra step for CO₂ splitting. More importantly, in non-thermal plasma regime, energy can be delivered efficiently into the vibrational dissociation channel of CO₂ while minimize the heating of gas via other channels, resulting in a potential to achieve high energy efficiency. In addition, the plasma-based CO₂ dissociation could potentially offer a sustainable route for syngas production as an alternative to coal gasification or natural gas reforming which is not a CO₂ neutral.

There is a possibility for the direct production of valuable chemicals through plasma-based capture and conversion of CO₂. In this case, a mixture of solid sorbent with catalysts can be used or dual function catalysts need to be developed to work effectively under plasma condition. The possible application scenario is shown in FIG. 10 B. Different with the previous case, H₂ produced from water electrolysis can be fed into the plasma reactor and react with capture CO₂ to produce valuable hydrocarbons or oxygenates with the existence of catalysts and the subsequent thermal chemical process will not be needed.

Although the FT synthesis and methanol synthesis process are mature technology, they are also highly stationary with low tolerance to variations. Direct integration with fluctuating input from renewable energy supply will be difficult, hydrogen needs to be available at a constant rate, hence additional facilities for storage will be needed. In addition, large scale is normally required for economic operation of those process, limiting the application in small scale decentralized or distributed cases. The plasma process could show its advantage regarding those problems.

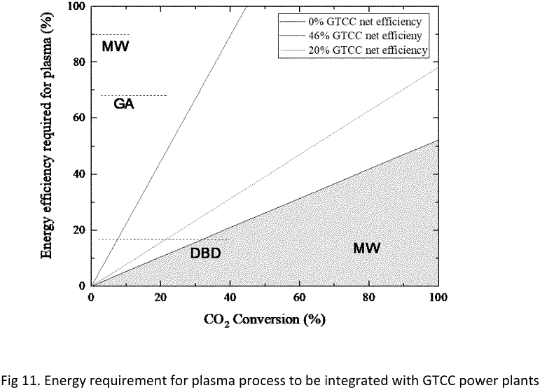

Besides the direct air capture and integration with the renewable energy source, the plasma-based capture and conversion of CO₂ can also be considered for the conventional power generation sector such as coal or gas-fired power plants. Taking a GTCC power plant as an example, a plasma system integrated with the power plant and using part of the electricity generated. Considering the energy released from CH₄ combustion is 9.25 eV/mol, GTCC has an efficiency of 60% and 2.9 eV/mole is required for CO₂ splitting, the energy efficiency requirement for plasma as a function of CO₂ conversion is shown in FIG. 11. To have net electricity generation from the power plant (GTCC net efficiency > 0%), the energy efficiency of the plasma process needs to be higher than the critical values indicated as the black line. Higher net efficiency means more net electricity output from the plants which requires higher energy efficiency of the plasma process for CO₂ treatment. Up to 14% energy penalty has been reported for CO₂ capture integrated with GTCC. If the same energy penalty considered (corresponds to the GTCC net efficiency 46%), much higher energy efficiency will be required (indicated as the red line). More importantly, the CO₂ conversion can never exceed 44.7% without reducing the net efficiency. The energy efficiency and conversion may vary with different reactor types and operating condition. Gliding arc showed higher energy efficiency (up to 60%) at atmospheric pressure with conversion below 10%. Normally 40-50% energy efficiency and 10-20% conversion was achieved in MW reactor, some cases with supersonic flow reported conversion up to 90% or energy efficiency up to 80%. DBD has a typical conversion up to 30% with energy efficiency up to 10%. Combining the energy consideration for the power plants, it can be seen that even with high conversion, plasma process which has low energy efficiency will not be suitable. On the other hand, some cases with GA and MW already showed an energy efficiency that meets the requirement. Based on a sensitivity analysis, improving the conversion can be effective to lower the price of CO due to the high cost on separation. It should be noted that for conversion to increase 1%, the energy efficiency of the plasma process needs to be increased at least 0.52% to maintain net electricity production form the power plants.

The present invention is concerned with the capture and splitting of CO₂ by using DBD plasma reactor packed with hydrotalcite. Plasma induced desorption of CO₂ was observed shortly after the plasma ignition and it stopped instantly when the plasma was switched off. During the cyclic operation of CO₂ adsorption and desorption, CO was produced at the beginning of the plasma exposure and the conversion of CO₂ decrease with the time. The average conversion achieved during the CO production period is 41.14%. In this case, the average energy efficiency for CO₂ splitting is 0.41%. The reason for the low efficiency is mainly caused by the existence of Ar with high concentration. Based on the concept of plasma-based CO₂ capture and conversion described in this invention, applications can be developed towards the storage of renewable electricity. Two major scenarios start from DAC have been proposed including syngas production centered “power to gas/liquid” and direct synthesis of oxygenates and hydrocarbons. Besides, the plasma process integrated with the IGCC power plant has been considered for the CO₂ emission reduction and utilization from a point source. It has been presented in this invention that the CO₂ capture and conversion can be merged into one process with a plasma-sorbent system.

1-15. (canceled)

16. A process for CO₂ capture and production of CO, the process comprising:
i) providing a CO₂ containing gas flow;
ii) adsorbing CO₂ from the CO₂ containing gas flow on a sorbent;
iii) applying plasma conditions on the CO₂ adsorbed sorbent to allow for desorption of CO₂ from the CO₂ adsorbed sorbent and conversion to CO; and
iv) collecting CO from the gas flow of step iii).

17. The process according to claim 16, wherein the gas flow of step iii) is again subjected to step ii) for adsorbing unreacted CO₂.

18. The process according to claim 16, wherein in step i) air is used as the CO₂ containing gas flow.

19. The process according to claim 16, wherein steps ii) and iii) are carried out in parallel for continuous capture and conversion of CO₂.

20. The process according to claim 16, wherein steps ii) and iii) are carried out in series for capture and conversion of CO₂ with recycling of unreacted CO₂.

21. The process according to claim 16, wherein step iii) is carried out in the presence of H₂ for the production of syngas.

22. The process according to claim 21, wherein a ratio between H₂ and CO is in a range from 1:1 to 6:1.

23. The process according to claim 21, wherein the H₂ is produced from electrolysis.

24. The process according to claim 16, wherein the plasma conditions applied include a frequency of 50 kHz to 1 MHz and a discharge power of 10 W to 2 kW.

25. The process according to claim 16, wherein the sorbent is chosen from the group including hydrotalcites, zeolites, activated carbon, solid supported amines, solid supported metal organic frameworks, or any combination thereof.

26. The process according to claim 16, wherein a shape of the sorbent is chosen from the group including pellets, spheres, and 3D printed structures to optimize the plasma discharge and the adsorption capacity and minimize the pressure drop.

27. The process according to claim 16, wherein the process is used for syngas production.

28. The process according to claim 27, wherein the syngas produced is used for the production of hydrocarbons.

29. An apparatus for CO₂ capture and production of CO comprising at least two reactors connected in parallel, wherein at least one reactor is configured for adsorbing CO₂ from the CO₂ containing gas flow on a sorbent and at least one reactor is configured for desorption of CO₂ from CO₂ adsorbed sorbent and conversion to CO, and wherein the at least two reactors are configured to apply plasma conditions.

30. An apparatus for CO₂ capture and production of CO comprising at least two reactors connected in series, wherein at least one reactor is configured for adsorbing CO₂ from the CO₂ containing gas flow on a sorbent and at least one reactor is configured for desorption of CO₂ from CO₂ adsorbed sorbent and conversion to CO, and wherein the at least two reactors are configured to apply plasma conditions.
